(19) United States
(12) Patent Application Publication
(10) Pub. No.: US 2022/0334593 A1
(43) Pub. Date: Oct. 20, 2022

(54) TRANSPORT CONTROL METHOD, TRANSPORT CONTROL APPARATUS, AND TRANSPORT CONTROL SYSTEM

(71) Applicant: NEC Corporation, Minato-ku, Tokyo (JP)

(72) Inventor: Taichi KUMAGAI, Tokyo (JP)

(73) Assignee: NEC Corporation, Minato-ku, Tokyo (JP)

(21) Appl. No.: 17/640,853

(22) PCT Filed: Sep. 30, 2019
(86) PCT No.: PCT/JP2019/038554

§ 371 Date: Mar. 7, 2022

(51) Int. Cl. G05D 1/02

(52) U.S. Cl. CPC G05D 1/0287; G05D 2201/0216

(57) ABSTRACT

In order to transport an object appropriately by one or more transport apparatuses, a transport control apparatus 100 includes: an obtaining section 121 configured to obtain operation information related to operation of an object 200 in response to first control information for controlling one or more transport apparatuses 301 and 302 transporting the object 200; and an identifying section 123 configured to identify second control information used for controlling the one or more transport apparatuses 300, based on the operation information related to the operation of the object 200 in response to the first control information.

### BACKGROUND

### Technical Field

The present invention relates to a transport control method, a transport control apparatus, and a transport control system for controlling operation of a transport apparatus transporting an object.

### Background Art

In production sites, such as a factory, and the like, transport apparatuses such as an automated guided robot and an automated guided vehicle (AGV) are used to transport a transport object (simply referred to as an object below) such as a load. Such a transport apparatus receives instruction information from a control apparatus and adjusts a transport route, transport velocity, and the like in accordance with the instruction information, to transport an object.

For example, PTL 1 discloses a robot system placing an object on top boards of two respective robot, for transport. In the robot system, a slave robot operates in cooperation with a master robot to transport the object. In the robot system, for example, delay in response from the slave robot (another robot) is measured in advance in consideration that delay occurs between actual operation and a movement instruction among the robots, to model other's movement control responsiveness.

PTL 2 discloses a traveling control method for controlling traveling along a guiding line, based on a detection signal from a line sensor detecting the guiding line, for performing control considering curve traveling of an automated guided conveyor.

Further, PTL 3 discloses a control parameter configuration method including: outputting a step drive signal from a personal computer to a transport apparatus to drive a motor of the transport apparatus; transmitting information of the rotational speed of the motor; and determining, in the personal computer, a function related to the rotational speed of the motor and time.

Furthermore, PTL 4 discloses an automatic drive control apparatus of a conveyor cart, the automatic drive control apparatus including: detecting, by a magnetic force detection means included in an automated guided cart, magnetic force generated from a traveling base line; measuring the attitude and displacement of the automated guided vehicle, based on the detection; and performing control for eliminating a difference between the result of the measurement and a command from a management control computer 34.

### CITATION LIST

### Patent Literature

[PTL 1] JP 2015-099524 A
[PTL 2] JP 2005-071128 A
[PTL 3] JP 11-194821 A
[PTL 4] JP 08-202449 A

### SUMMARY

### Technical Problem

However, in a case where a transport apparatus transports an object, movement characteristics of the object changes depending on the situation such as unevenness of a floor surface, the degree of slipping, and the mass and kind of the object as well as operation of the transport apparatus. For this reason, with the techniques disclosed in PTLs 1 to 4 and the like, for example, an object cannot be transported appropriately in consideration of how an object has actually moved.

An example object of the present invention is to provide a transport control method, a transport control apparatus, and a transport control system that enable appropriate transport of an object by one or more transport apparatuses.

### Solution to Problem

According to an aspect of the present invention, a transport control method includes: obtaining operation information related to operation of an object in response to first control information for controlling one or more transport apparatuses transporting the object; and identifying second control information used for controlling the one or more transport apparatuses, based on the operation information related to the operation of the object in response to the first control information.

According to an aspect of the present invention, a transport control apparatus includes: an obtaining section configured to obtain operation information related to operation of an object in response to first control information for controlling one or more transport apparatuses transporting the object; and an identifying section configured to identify second control information used for controlling the one or more transport apparatuses, based on the operation information related to the operation of the object in response to the first control information.

According to an aspect of the present invention, a transport control system causes a computer to execute processing including: obtaining operation information related to operation of an object in response to first control information for controlling one or more transport apparatuses transporting the object; and identifying second control information used for controlling the one or more transport apparatuses, based on the operation information related to the operation of the object in response to the first control information.

### Advantageous Effects of Invention

According to an aspect of the present invention, it is possible to transport an object appropriately by one or more transport apparatuses. Note that, according to the present invention, instead of or together with the above effects, other effects may be exerted.

### BRIEF DESCRIPTION OF THE DRAWINGS

FIG. 1 is an explanatory diagram illustrating an example of a schematic configuration of a transport control system 1 according to an example embodiment of the present invention;

FIG. 2 is a block diagram illustrating an example of a hardware configuration of a transport control apparatus 100 according to a first example embodiment;

FIG. 3 is a block diagram illustrating an example of a configuration implemented with a transport control apparatus 100, transport apparatuses 301 and 302, and an external sensor apparatus 40 in a transport control system 1 according to the first example embodiment;

FIG. 4 is a diagram illustrating a concrete example of information related to control parameters managed by a control parameter management section 130;

FIG. 5 is a flowchart for describing a concrete example of a flow of processing according to the transport control apparatus 100;

FIG. 6 is a diagram for describing a concrete example of a data table in which path information and second control information are associated with each other;

FIG. 7 is a block diagram illustrating an example of a schematic configuration of a transport control apparatus 100 according to a second example embodiment; and

FIG. 8 is a diagram for describing a flow of processing performed by the transport control apparatus 100 according to the second example embodiment.

### DESCRIPTION OF THE EXAMPLE EMBODIMENTS

Hereinafter, example embodiments of the present invention will be described in detail with reference to the accompanying drawings. Note that, in the Specification and drawings, elements to which similar descriptions are applicable are denoted by the same reference signs, and overlapping descriptions may hence be omitted.

Descriptions will be given in the following order.

1. Overview of Example Embodiments of the Present Invention

2. Configuration of System

3. First Example Embodiment
3.1. Configuration of Transport Control Apparatus 100
3.2. Operation Example

4. Second Example Embodiment
4.1. Configuration of Transport Control Apparatus 100
4.2. Operation Example

5. Other Example Embodiments

### 1. Overview of Example Embodiments of the Present Invention

First, an overview of example embodiments of the present invention will be described.

### (1) Technical Issues

In production sites, such as a factory, and the like, transport apparatuses such as an automated guided robot and an automated guided vehicle (AGV), which autonomously travel to transport a substance are used to transport a transport object (simply referred to as an object below) such as a load. Such a transport apparatus receives instruction information from a control apparatus and adjusts a transport route, transport velocity, and the like in accordance with the instruction information, to transport an object.

However, in a case where a transport apparatus transports an object, movement characteristics of the object changes depending on the situation such as unevenness of a floor surface, the degree of slipping, and the mass and kind of the object as well as conditions of the transport apparatus. For this reason, it has been impossible, for example, to transport an object appropriately by one or more transport apparatuses.

For example, look at a case where control of a transport apparatus is performed based on a measurement result obtained by a sensor installed in the transport apparatus. In this case, information collected by the sensor indicates operation of the transport apparatus, and hence there is a difference between a detection result from the sensor and the amount of actual movement of an object transported by the transport apparatus, in some cases. For example, in a case where the friction coefficient of a floor with which wheels included in the transport apparatus are in contact is small, an actual movement distance may be longer than a movement distance calculated based on rotation of the wheels. In contrast, in a case where the floor is uneven, the wheels do not rotate as expected although it is attempted to cause the transport apparatus to travel at a desired velocity instructed to the transport apparatus, and hence the actual measured value of velocity may be smaller than an instructed value.

In view of these, an example object of the present example embodiment is to transport an object appropriately by one or more transport apparatuses.

### (2) Operation Example

An example embodiment of the present invention includes: obtaining operation information related to operation of an object in response to first control information for controlling one or more transport apparatuses transporting the object; and identifying second control information used for controlling the one or more transport apparatuses, based on the operation information related to the operation of the object in response to the first control information.

With this, it is possible, for example, to transport an object appropriately by one or more transport apparatuses. Note that the operation example described above is a concrete example of an example embodiment of the present invention, and the embodiments of the present invention are apparently not limited to the operation example described above.

### 2. Configuration of System

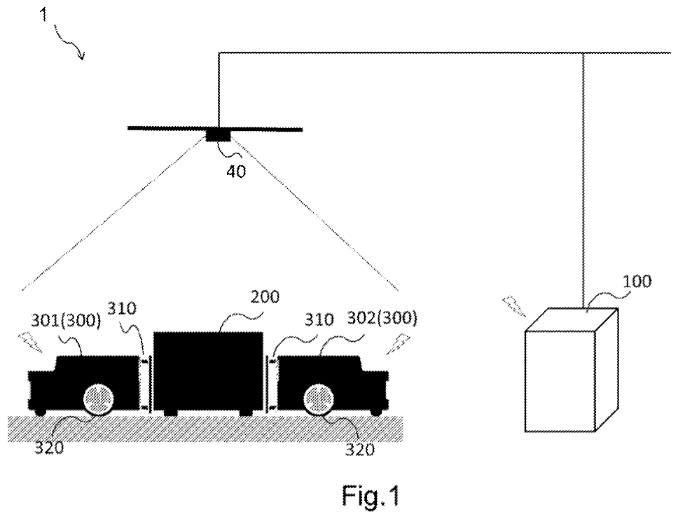

With reference to FIG. 1, an example of a configuration of a transport control system 1 according to example embodiments of the present invention will be described. FIG. 1 is an explanatory diagram illustrating an example of a schematic configuration of a transport control system 1 according to the example embodiments of the present invention.

With reference to FIG. 1, the transport control system 1 includes a transport control apparatus 100, an object 200, a plurality of transport apparatuses 301 and 302 (referred to simply as “transport apparatuses 300” unless there is a particular reason for distinguishing the transport apparatuses 301 and 302), and an external sensor apparatus 40.

(Transport Control Apparatus 100)

The transport control apparatus 100, for example, communicates with the transport apparatuses 300 and the external sensor apparatus 40 to transmit, to the transport apparatuses 300, instruction information for controlling movement of the object 200. Specifically, the instruction information includes the direction in which the transport apparatuses 300 are instructed to transport the object 200 (also referred to as an instructed transport direction below) and the velocity at which the transport apparatuses 300 are instructed to transport the object 200 (also referred to as an instructed transport velocity below).

(Object 200)

The object 200 is, for example, a movable body such as a cart loaded with a load and is transported in a state of being held between the transport apparatuses 301 and 302 as illustrated in FIG. 1, for example.

(Transport Apparatus 300)

The transport apparatus 300 is a transport apparatus such as an automated guided robot or an automated guided vehicle (AGV) and includes an elastic mechanism 310 for pressurizing the object 200 and a plurality of wheels 320 using a motor as driving force to move. The transport apparatus 300 controls operation of the elastic mechanism 310 and the wheels 320, based on the instruction information from the transport control apparatus 100.

Concretely, as illustrated in FIG. 1, one transport apparatus 300 (for example, the transport apparatus 301) transports the object 200 in cooperation with another transport apparatus 300 (for example, the transport apparatus 302).

The transport apparatuses 301 and 302 are apparatuses cooperating with each other to transport the object 200. Concretely, the transport apparatuses 301 and 302 are provided with respective elastic mechanisms 310 as means for pressurizing the object 200 from opposing directions to hold the object 200 therebetween, the elastic mechanisms 310 each being formed of two plates mechanically connected to each other with springs, for example. Concretely, the elastic mechanisms 310 are rotatably provided to respective bodies of the transport apparatuses 301 and 302. In other words, the elastic mechanisms 310 rotatably provided to the respective transport apparatuses 301 and 302 pressurize the object 200 from the opposite directions. Each of the transport apparatuses 301 and 302 measures the distance between the plates forming the corresponding elastic mechanism 310 to detect the amount of pressure to the object 200.

The transport apparatuses 301 and 302 drive the wheels 320 to rotate while maintaining the state of holding the object 200 therebetween so that the amount of pressure to the object 200 reaches a desired value, based on the amount of pressure to the object 200, for example. In this way, the transport apparatuses 301 and 302 can rotatably transport the object 200.

(External Sensor Apparatus 40)

The external sensor apparatus 40 is a sensor apparatus that detects the position of the object 200, for example, and transmits detection data to the transport control apparatus 100. Specifically, the external sensor apparatus 40 is an apparatus that captures an image of the inside of a field in which the object 200 can move, and includes a depth camera and/or a stereo camera, for example. The depth camera is a camera capable of capturing a depth image in which each image pixel value indicates the distance from the camera to the object 200. The stereo camera is a camera that captures images of the object 200 from a plurality of different directions by using a base camera and a reference camera, to enable measurement related to a depth direction of the object 200.

### 3. First Example Embodiment

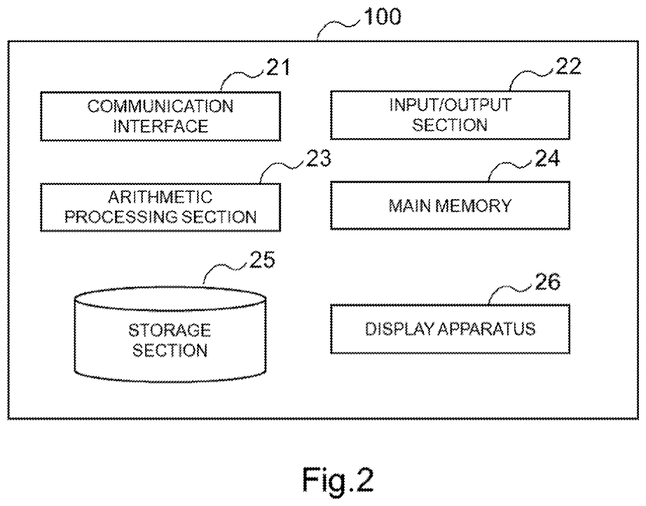

Next, a transport control apparatus 100 according to a first example embodiment will be described with reference to FIGS. 2 to 6.

### 3.1. Configuration of Transport Control Apparatus 100

FIG. 2 is a block diagram illustrating an example of a hardware configuration of the transport control apparatus 100 according to the first example embodiment. With reference to FIG. 2, the transport control apparatus 100 includes a communication interface 21, an input/output section 22, an arithmetic processing section 23, a main memory 24, and a storage section 25.

The communication interface 21 transmits and/or receives data to and/or from an external apparatus. For example, the communication interface 21 communicates with an external apparatus via a wired communication path or wireless channel.

The arithmetic processing section 23 is, for example, a central processing unit (CPU), a graphics processing unit (GPU), or the like. The main memory 24 is, for example, a random access memory (RAM), a read only memory (ROM), or the like. The storage section 25 is, for example, a hard disk drive (HDD), a solid state drive (SSD), a memory card, or the like. The storage section 25 may be a memory such as a RAM or a ROM.

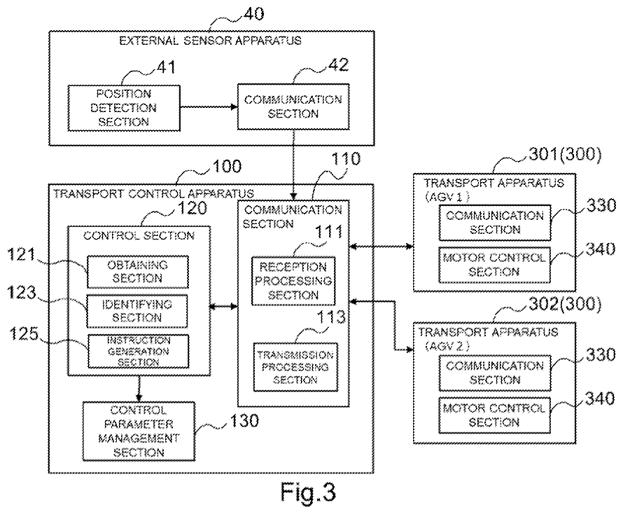

In the transport control apparatus 100, for example, programs for transport control stored in the storage section 25 is read out to the main memory 24, and the arithmetic processing section 23 executes the program, to thereby implement function sections as those illustrated in FIG. 3. These programs may be read out first to the main memory 24 and then executed, or may be executed without being read out to the main memory 24. The main memory 24 and the storage section 25 also function to store information and data held by constituent elements included in the transport control apparatus 100.

The above-described program can be stored in various types of non-transitory computer readable media, to be provided to a computer. The non-transitory computer-readable media include various types of tangible storage media. Examples of the non-transitory computer-readable media include a magnetic recording media (e.g., a flexible disk, a magnetic tape, and a hard disk drive), a magneto-optical recording media (e.g., a magneto-optical disk), a compact disk-ROM (CD-ROM), a CD-recordable (CD-R), a CD-rewritable (CD-R/W), a semiconductor memory (e.g., a mask ROM, a programmable ROM (PROM)), an erasable PROM (EPROM), a flash ROM, and a RAM. The programs may be provided to the computer by way of various types of transitory computer readable media. Examples of the transitory computer-readable media include an electric signal, an optical signal, and an electromagnetic wave. Such a transitory computer-readable medium can provide the programs to the computer through a wired channel such as an electric wire or an optical fiber, or a wireless channel.

The display apparatus 26 is an apparatus, such as a liquid crystal display (LCD), a cathode ray tube (CRT) display, or a monitor, that displays a screen corresponding to rendering data processed by the arithmetic processing section 23.

FIG. 3 is a block diagram illustrating an example of a configuration implemented with the transport control apparatus 100, transport apparatuses 301 and 302, and an external sensor apparatus 40 in a transport control system 1 according to the first example embodiment.

With reference to FIG. 3, the transport control apparatus 100 includes a communication section 110, a control section 120, and a control parameter management section 130. Concretely, the communication section 110 includes a reception processing section 111 and a transmission processing section 113, and the control section 120 includes an obtaining section 121, an identifying section 123, and an instruction generation section 125. The transport apparatus 300 includes a communication section 330 and a motor control section 340. Further, the external sensor apparatus 40 includes a position detection section 41 and a communication section 42. Concrete operation of each of these function sections will be described later.

### 3.2. Operation Example

In the first example embodiment, an operation example for appropriately transporting the object 200 by the transport apparatus 300 will be described as follows.

According to the first example embodiment, the transport control apparatus 100 (the obtaining section 121) obtains operation information related to operation of the object 200 in response to first control information for controlling one or more transport apparatuses 300 transporting the object 200. The transport control apparatus 100 (the identifying section 123) identifies second control information used for controlling the one or more transport apparatuses 300, based on the operation information related to the operation of the object 200 in response to the first control information.

According to the first example embodiment, it is possible to perform control for appropriately transporting the object 200 in accordance with the second control information identified based on the operation information related to the operation of the object 200 in response to the first control information.

### (1) First Control Information

The first control information is first instruction information given to the transport apparatus 300 as an instruction of operation for transport. The transport apparatus 300 operates based on the first control information received from the transport control apparatus 100. The first instruction information includes, for example, information related to an instructed transport direction, which is the direction in which the transport apparatus 300 transports the object 200, and an instructed transport velocity, which is the velocity at which the transport apparatus 300 transports the object 200.

Concretely, the first instruction information is used to identify a control parameter for transporting the object 200, the control parameter corresponding to the state of a floor surface on which the object 200 to be transported by the transport apparatus 300 is located (a friction coefficient, unevenness of the surface, and/or the like) and the weight of the object 200 to be transported by the transport apparatus 300. Concrete operation for identifying a control parameter will be described later.

The transport control apparatus 100 (the instruction generation section 125) generates the first instruction information indicating the instructed transport direction and the instructed transport velocity. The transport control apparatus 100 transmits, from the transmission processing section 113, the generated instruction information to the one or more transport apparatuses 300.

Then, the transport apparatus 300 receives, at the communication section 330, the first instruction information and operates according to the motor control section 340 so as to enable transport of the object 200 in the instructed transport direction at the instructed transport velocity.

### (2) Operation Information Related to Operation of Object 200

The operation information related to the operation of the object 200 is information indicating operation of the object 200 corresponding to the first instruction information. The operation information related to the operation of the object 200 includes the moving velocity and acceleration, for example.

—Moving Velocity—

An actual measured value of a moving velocity (actual velocity) applied to the object 200 is an actual measured value of a start velocity Vstart applied to the object 200 from a standstill state of the object 200, in response to the first instruction information. For example, the heavier the object 200 is, the higher torque the one or more transport apparatuses 300 (the motor control sections 340) cause the motor(s) to generate at the time when the object 200 starts to move, in order to enable transport at the instructed transport velocity. Hence, the heavier the object 200 is, the smaller the actual measured value of the start velocity Vstart tends to be. In this way, it is possible to estimate information related to the weight of the object 200, based on the actual measured value of the start velocity Vstart.

The actual measured value of the start velocity Vstart can be obtained, for example, as follows.

For example, the external sensor apparatus 40 detects, by the position detection section 41, position information of the object 200, based on a captured image of the object 200 and transmits, from the communication section 42, the position information to the transport control apparatus 100. The transport control apparatus 100 (the reception processing section 111) receives the position information of the object 200 transmitted from the external sensor apparatus 40 (the communication section 42).

In this case, by using the position information of the object 200, the transport control apparatus 100 (the obtaining section 121) can obtain the actual measured value of the start velocity Vstart. Concretely, by calculating a differential value between two or more pieces of position information of the object 200 different in time, the actual measured value of the start velocity Vstart is calculated.

The transport apparatus 300 obtains an actual measured value of transport operation in response to the first instruction information (for example, an actual measured value of the transport velocity) and transmits, from the communication section 330, the obtained actual measured value to the transport control apparatus 100. The transport control apparatus 100 (the reception processing section 111) receives the actual measured value of the transport operation in response to the first instruction information, from the transport apparatus 300.

In this case, by using the actual measured value of the transport operation in response to the first instruction information (for example, an actual measured value of the transport velocity), the transport control apparatus 100 (the obtaining section 121) can obtain the actual measured value of the start velocity Vstart.

Note that the information related to the moving velocity applied to the object 200 in response to the first instruction information is not limited to the actual measured value of the start velocity Vstart and may be information related to time response with respect to the velocity of the object 200 from a standstill state of the object 200 to a constant velocity traveling state (a steady state) in response to the first instruction information, for example.

Acceleration

The operation information related to the operation of the object 200 in response to the first instruction information may include information related to an acceleration a(t) given to the object 200 at a time point tin response to the first instruction information. For example, when the object 200 is lighter, the one or more transport apparatuses 300 enable transport at the instructed transport velocity, with a smaller load (torque the motor(s) are caused to generate). Hence, the lighter the object 200 is, the higher the acceleration a(t) becomes. In this way, it is possible to estimate information related to the weight of the object 200, based on the acceleration a(t).

The acceleration a(t) can also be obtained by using the position information of the object 200 received from the external sensor apparatus 40 or using the actual measured value of the transport operation (for example, the actual measured value of the transport velocity) in response to the first instruction information received from the one or more transport apparatuses 300.

Others

The operation information related to the operation of the object 200 is not limited to the above-described examples (the actual measured value of the start velocity Vstart, the acceleration a(t), and the like) and may be information of positions at which the object 200 travels, the moving amount in a predetermined time period, or the like, for example.

### (3) Second Control Information

The second control information is a parameter for control to be used for generating second instruction information about which the transport apparatus 300 is instructed. Specifically, the second instruction information is instruction information transmitted to the transport apparatus 300 after the above-described first instruction information. For example, the second instruction information includes information related to an instructed transport direction, which is the direction in which the transport apparatus 300 transports the object 200, and an instructed transport velocity, which is the velocity at which the transport apparatus 300 transports the object 200.

The parameter for control includes, for example, the maximum acceleration, the velocity, and the distance for stop control for the transport apparatus 300 to allow.

The transport control apparatus 100 (the identifying section 123) identifies a parameter related to the maximum acceleration, the velocity, and the distance for stop control for the transport apparatus 300 to allow, based on the actual measured value of the start velocity Vstart or the acceleration a(t) described above. The transport control apparatus 100 (the instruction generation section 125) then generates, as the second instruction information, transport instruction information for actually transporting the object 200 in accordance with a desired transport route, by using the parameter identified by the identifying section 123.

In a case where the one or more transport apparatuses 300 are configured of the two transport apparatuses 301 and 302 pressurizing the object 200 from opposite directions to hold the object 200 therebetween, the parameter for control may include the amounts of pressure to the object 200 for the two respective transport apparatuses 301 and 302 to allow.

Identifying of Second Control Information

Concretely, identifying of the second control information is performed as follows. Specifically, the transport control apparatus 100 (the identifying section 123) identifies one control parameter (the second control information) from among two or more control parameters used for determining a transport instruction to the one or more transport apparatuses 300, based on the operation information related to the operation of the object 200 in response to the first control information.

The two or more control parameters are managed by the control parameter management section 130, for example. In this case, the transport control apparatus 100 (the identifying section 123) accesses the control parameter management section 130 to identify, as the second control information, the control parameter associated with the operation information related to the operation of the object 200 in response to the first instruction information.

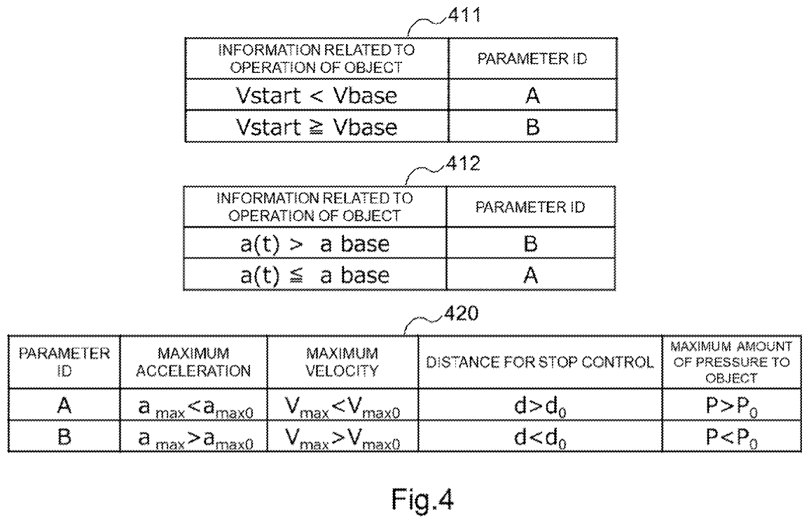

For example, the control parameter management section 130 manages the information related to control parameters as illustrated in FIG. 4.

FIG. 4 is a diagram illustrating a concrete example of the information related to control parameters managed by the control parameter management section 130.

With reference to FIG. 4, the control parameter management section 130 includes data tables 411 and 412 each indicating a correspondence relationship between each piece of operation information related to operation of the object 200 and a parameter ID identifying a control parameter.

With reference to the data table 411, the actual measured value of the start velocity Vstart smaller than a predetermined base start velocity Vbase is associated with a parameter ID “A” suitable for a case where the object 200 is heavy. The actual measured value of the start velocity Vstart equal to or higher than a predetermined base start velocity Vbase is associated with a parameter ID “B” suitable for a case where the object 200 is light.

With reference to the data table 412, the acceleration a(t) higher than a predetermined base acceleration abase is associated with a parameter ID “B” suitable for the case where the object 200 is light. The acceleration a(t) equal to or lower than the predetermined base acceleration abase is associated with the parameter ID “A” suitable for the case where the object 200 is heavy.

The control parameter management section 130 further includes a data table 420 indicating a correspondence relationship between each parameter ID and control parameters.

With reference to the data table 420, a maximum acceleration aₘₐₓ corresponding to the parameter ID “A” is configured to a value smaller than a predetermined base maximum acceleration aₘₐₓ₀. A maximum velocity Vₘₐₓ corresponding to the parameter ID “A” is configured to a value smaller than a predetermined base maximum velocity Vₘₐₓ₀. Note that the maximum velocity Vₘₐₓ may be configured for each of a time of moving straight ahead and a time of rotating. A distance d for stop control corresponding to the parameter ID “A” is configured to a value greater than a predetermined distance do. Further, a maximum amount P of pressure to the object 200 corresponding to the parameter ID “A” is configured to a value greater than a predetermined maximum amount Po of pressure. Such a control parameter identified by the parameter ID “A” described above may be selected in a case where the object 200 is assumed to be heavy based on operation of the object 200 in response to the first instruction information, for example.

In contrast, the maximum acceleration aₘₐₓ corresponding to the parameter ID “B” is configured to a value greater than the predetermined base maximum acceleration aₘₐₓ₀, the maximum velocity Vₘₐₓ corresponding to the parameter ID “B” is configured at a value greater than the predetermined base maximum velocity Vₘₐₓ₀, the distance d for stop control corresponding to the parameter ID “B” is configured at a value smaller than a predetermined distance do, and the maximum amount P of pressure to the object 200 corresponding to the parameter ID “B” is configure to a value smaller than the predetermined maximum value Po of pressure. Such a control parameter identified by the parameter ID “B” described above may be selected in a case where the object 200 is assumed to be light based on operation of the object 200 in response to the first instruction information, for example.

Note that each of the two or more control parameters is not limited to a case of having a value configured based on the weight of the object 200 as described above and may be, for example, a value configured based on a friction coefficient of a floor surface on which the object 200 moves or the center of gravity. Concretely, the control parameter management section 130 may manage control parameters suitable for the friction coefficient of the floor surface or the deviation of the center of gravity in addition to the control parameters identified by the parameter IDs “A” and “B” described above. For example, in a case where the friction coefficient of the floor on which the object 200 moves is estimated to be high based on operation of the object 200 in response to the first instruction information (for example, a case where the friction coefficient is higher than a predetermined threshold), a control parameter identified by the parameter ID “A” may be selected. In contrast, in a case where the friction coefficient of the floor on which the object 200 travels is estimated to be low based on operation of the object 200 in response to the first instruction information (for example, a case where the friction coefficient is equal to or lower than the predetermined threshold), a control parameter identified by the parameter ID “B” may be selected.

### (4) Flow of Processing

Next, a concrete example of a flow of processing performed by the transport control apparatus 100 will be described.

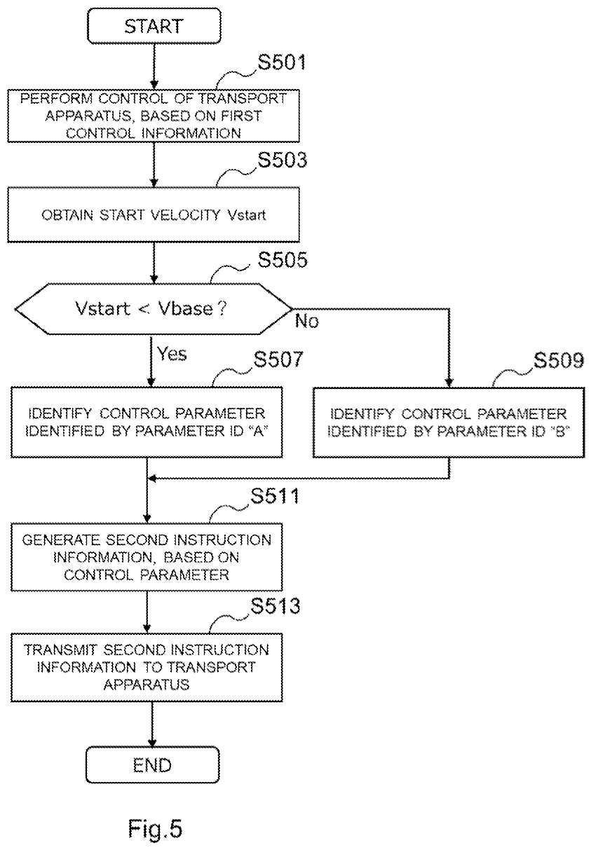

FIG. 5 is a flowchart for describing a concrete example of a flow of processing performed by the transport control apparatus 100. In the processing illustrated in FIG. 5, the above-described data table 411 illustrated in FIG. 4 is assumed to be used.

With reference to FIG. 5, in step S501, the transport control apparatus 100 (the control section 120) performs control of the transport apparatuses 301 and 302, based on the first instruction information. Specifically, the transport control apparatus 100 (the control section 120) transmits the first instruction information to each of the transport apparatuses 301 and 302. In response to this, the transport apparatuses 301 and 302 (the motor control sections 340) perform operation to follow an instructed transport direction and an instructed transport velocity indicated by the first instruction information. Thereafter, the processing advances to step S503.

In step S503, the transport control apparatus 100 (the obtaining section 121) obtains an actual measured value of the start velocity Vstart applied to the object 200 in response to the first instruction information, and the processing advances to step S505.

In step S505, the transport control apparatus 100 (the identifying section 123) determines whether or not the actual measured value of the start velocity Vstart is smaller than the predetermined base start velocity Vbase. In a case where the actual measured value of the start velocity Vstart is smaller than the predetermined base start velocity Vbase (S505: Yes), the processing advances to step S507; otherwise (S505: No), the processing advances to step S509.

In step S507, the transport control apparatus 100 (the identifying section 123) identifies, as the second control information, a control parameter identified by the parameter ID “A”, and the processing advances to step S511.

In step S509, the transport control apparatus 100 (the identifying section 123) identifies, as the second control information, a control parameter identified by the parameter ID “B”, and the processing advances to step S511.

In step S511, the transport control apparatus 100 (the instruction generation section 125) generates the second instruction information by using the control parameter identified in step S507 or step S509, and the processing advances to step S513.

In step S513, the transport control apparatus 100 (the transmission processing section 113) transmits the second instruction information generated in step S511 to each of the transport apparatuses 301 and 302, and the processing illustrated in FIG. 5 is terminated.

In the processing illustrated in FIG. 5, by identifying a control parameter suitable for operation of the object 200, according to an actual measured value of the start velocity Vstart applied to the object 200 in response to the first instruction information, it is possible to transport the object 200 appropriately.

Note that various changes can be made to the processing illustrated in FIG. 5. For example, similar processing may be performed by using the acceleration a(t) instead of an actual measured value of the start velocity Vstart. In this case, the acceleration a(t) is obtained in step S503, and whether or not the acceleration a(t) is equal to or lower than the predetermined base acceleration abase is determined in step S505.

### (5) Other Examples

For example, the transport control apparatus 100 (the control parameter management section 130) may hold (manage) association information (a data table) in which path information and the second control information are associated with each other, the path information being information of a path to which the position where the operation of the object 200 in response to the first instruction information is performed belongs.

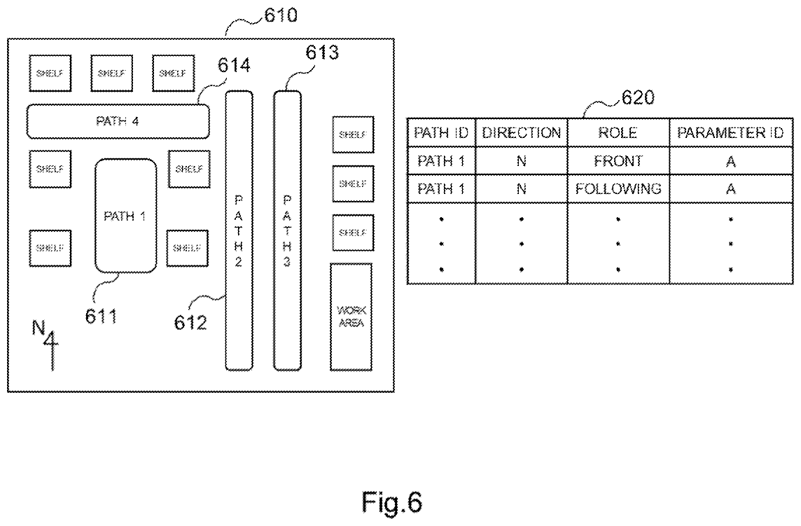

FIG. 6 is a diagram for describing a concrete example of a data table 620 in which the path information and the second control information are associated with each other.

With reference to FIG. 6, the transport control apparatus 100 (the control parameter management section 130) refers, for example, to map data 610 of a map where the object 200 can move, to identify a path to which the position where the operation of the object 200 in response to the first instruction information belongs, from among four paths 611, 612, 613, and 614 in which the object 200 can be transported. The transport control apparatus 100 (the control parameter management section 130) then associates path information related to the identified path and the second control information with each other to store the associated information in the data table 620.

With reference to FIG. 6, the control parameter management section 130 manages, as the data table 620, pieces of association information in which the parameter ID of a control parameter is associated with a path ID for identifying a path, a moving direction, and the role of the transport apparatus 300. In the data table 620, it is managed that, in a case where the path ID is “path 1”, the moving direction is north, and the transport apparatus is on the front side or the following side in the moving direction, a transport instruction for the transport apparatus is generated by using the control parameter identified by the parameter ID “A”.

In a case where the data table 620 as described above is managed, the transport control apparatus 100 (the instruction generation section 125) may use the association information (the data table 620) in which the path information and the second control information are associated with each other, to determine a transport instruction to the transport apparatuses 300 transporting the object moving at a position identified by the path information. In this way, in a case where a suitable control parameter is identified based on the first instruction information for the paths 611 to 614, the transport control apparatus 100 (the instruction generation section 125) can generate, by referring to the data table 620 managed by the control parameter management section 130, a transport instruction for the transport apparatus 300 by using the control parameter suitable for a case of passing each of the paths.

### 4. Second Example Embodiment

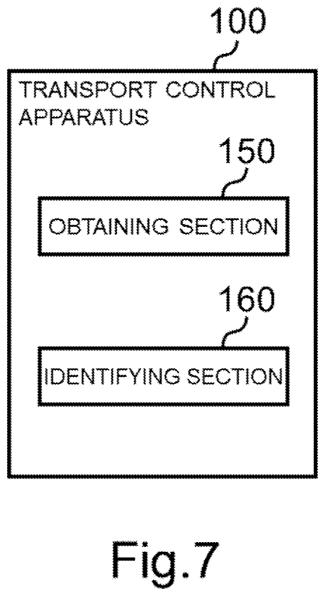

Next, a description will be given of a second example embodiment of the present invention with reference to FIG. 7. The above-described first example embodiment is a concrete example embodiment, whereas the second example embodiment is a more generalized example embodiment.

### 4.1. Configuration of Transport Control Apparatus 100

FIG. 7 is a block diagram illustrating an example of a schematic configuration of the transport control apparatus 100 according to a second example embodiment. With reference to FIG. 7, the transport control apparatus 100 includes an obtaining section 150 and an identifying section 160.

The obtaining section 150 and the identifying section 160 may be implemented with one or more processors, a memory (e.g., a nonvolatile memory and/or a volatile memory), and/or a hard disk. The obtaining section 150 and the identifying section 160 may be implemented with the same processor or may be implemented with separate processors. The memory may be included in the one or more processors or may be provided outside the one or more processors.

### 4.2. Operation Example

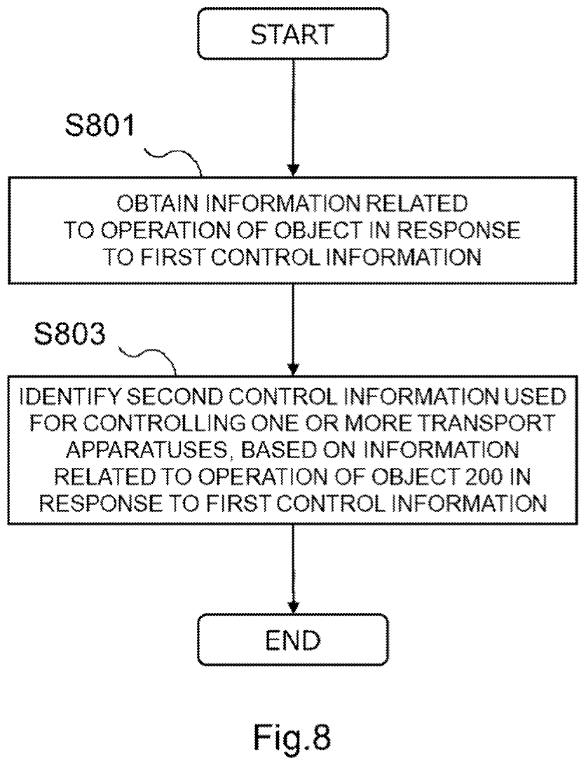

An operation example of the second example embodiment will be described. FIG. 8 is a diagram for describing a flow of processing performed by the transport control apparatus 100 according to the second example embodiment.

According to the second example embodiment, the transport control apparatus 100 (the obtaining section 150) obtains operation information related to operation of the object 200 in response to first control information for controlling the one or more transport apparatuses 300 transporting the object 200 (step S801). The transport control apparatus 100 (the identifying section 160) identifies second control information used for controlling the one or more transport apparatuses 300, based on the operation information related to the operation of the object 200 in response to the first control information (step S803).

Relationship with First Example Embodiment

As an example, the obtaining section 150 and the identifying section 160 of the second example embodiment may perform the operation of the obtaining section 121 and the operation of the identifying section 123 of the first example embodiment, respectively. In this case, the descriptions of the first example embodiment may also be applicable to the second example embodiment.

Note that the second example embodiment is not limited to this example.

The second example embodiment has been described above. According to the second example embodiment, it is possible to perform control for appropriately transporting the object 200 in accordance with the second control information identified based on the operation information related to the operation of the object 200 in response to the first control information, for example.

### 5. Other Example Embodiments

Descriptions have been given above of the example embodiments of the present invention. However, the present invention is not limited to these example embodiments. It should be understood by those of ordinary skill in the art that these example embodiments are merely examples and that various alterations are possible without departing from the scope and the spirit of the present invention.

For example, although the description has been given mainly using an example of transporting an object by using two transport apparatuses in the Specification, the present disclosure may be applied to an example of transporting an object by using a single transport apparatus or three or more transport apparatuses. The steps in the processing described in the Specification may not necessarily be executed in time series in the order described in the corresponding sequence diagram. For example, the steps in the processing may be executed in an order different from that described in the corresponding sequence diagram or may be executed in parallel. Some of the steps in the processing may be deleted, or more steps may be added to the processing.

An apparatus including constituent elements (e.g., the obtaining section and/or the identifying section) of the transport control apparatus described in the Specification (e.g., one or more apparatuses (or units) among a plurality of apparatuses (or systems) constituting the transport control apparatus or a module for one of the plurality of apparatuses (or systems)) may be provided. Moreover, methods including processing of the constituent elements may be provided, and programs for causing a processor to execute processing of the constituent elements may be provided. Moreover, non-transitory computer-readable recording media (non-transitory computer readable medium) having recorded thereon the programs may be provided. It is apparent that such apparatuses, systems, modules, methods, programs, and non-transitory computer-readable recording media are also included in the present invention.

The whole or part of the example embodiments disclosed above can be described as, but not limited to, the following supplementary notes.

### (Supplementary Note 1)

A transport control method comprising:

obtaining operation information related to operation of an object in response to first control information for controlling one or more transport apparatuses transporting the object; and

identifying second control information used for controlling the one or more transport apparatuses, based on the operation information related to the operation of the object in response to the first control information.

### (Supplementary Note 2)

The transport control method according to supplementary note 1, wherein the first control information is first instruction information given as an instruction to the one or more transport apparatuses.

### (Supplementary Note 3)

The transport control method according to supplementary note 2, wherein the first instruction information includes information related to an instructed transport direction given as an instruction to the one or more transport apparatuses.

### (Supplementary Note 4)

The transport control method according to supplementary note 2 or 3, wherein the first instruction information includes information related to an instructed transport velocity given as an instruction to the one or more transport apparatuses.

### (Supplementary Note 5)

The transport control method according to any one of supplementary notes 1 to 4, wherein the operation information related to the operation of the object in response to the first control information includes information related to the moving velocity applied to the object in response to the first control information.

### (Supplementary Note 6)

The transport control method according to supplementary note 5, wherein the moving velocity applied to the object in response to the first control information is an actual measured value of a start velocity applied to the object from a standstill state of the object, in response to the first control information.

### (Supplementary Note 7)

The transport control method according to any one of supplementary notes 1 to 6, wherein the operation information related to the operation of the object in response to the first control information includes information related to acceleration a(t) given to the object at a time point tin response to the first control information.

### (Supplementary Note 8)

The transport control method according to any one of supplementary notes 1 to 7, wherein the second control information is a parameter for control to be used for generating second instruction information to the one or more transport apparatuses.

### (Supplementary Note 9)

The transport control method according to supplementary note 8, wherein the parameter for control includes maximum acceleration for the one or more transport apparatuses to allow.

### (Supplementary Note 10)

The transport control method according to supplementary note 8 or 9, wherein the parameter for control includes velocity for the one or more transport apparatuses to allow.

### (Supplementary Note 11)

The transport control method according to any one of supplementary notes 8 to 10, wherein the parameter for control includes distance for stop control for the one or more transport apparatuses to allow.

### (Supplementary Note 12)

The transport control method according to any one of supplementary notes 8 to 11, wherein the one or more transport apparatuses include two transport apparatuses transporting the object in cooperation with each other.

### (Supplementary Note 13)

The transport control method according to any one of supplementary notes 8 to 12, wherein the identifying of the second control information includes identifying the second control information from among two or more control parameters used for determining a transport instruction to the one or more transport apparatuses, based on the operation information related to the operation of the object in response to the first control information.

### (Supplementary Note 14)

The transport control method according to any one of supplementary notes 1 to 13, further comprising holding association information in which path information and the second control information are associated with each other, the path information being information of a path to which a position where the operation of the object in response to the first control information is performed belongs.

### (Supplementary Note 15)

The transport control method according to supplementary note 14, further comprising using the association information in which the path information and the second control information are associated with each other, to determine a transport instruction to a transport apparatus transporting the object moving the position identified by the path information.

### (Supplementary Note 16)

A transport control apparatus comprising:

an obtaining section configured to obtain operation information related to operation of an object in response to first control information for controlling one or more transport apparatuses transporting the object; and

an identifying section configured to identify second control information used for controlling the one or more transport apparatuses, based on the operation information related to the operation of the object in response to the first control information.

### (Supplementary Note 17)

The transport control apparatus according to supplementary note 16, further comprising a transmission processing section configured to transmit instruction information for controlling the one or more transport apparatuses to the one or more transport apparatuses, based on the second control information.

### (Supplementary Note 18)

The transport control apparatus according to supplementary note 16 or 17, wherein the first control information is first instruction information for giving, to the one or more transport apparatuses, an instruction of operation for transport.

### (Supplementary Note 19)

The transport control apparatus according to any one of supplementary notes 16 to 18, wherein the second control information is a parameter for control to be used for generating second instruction information to the one or more transport apparatuses.

### (Supplementary Note 20)

The transport control apparatus according to any one of supplementary notes 16 to 19, wherein the one or more transport apparatuses include two transport apparatuses transporting the object in cooperation with each other.

### (Supplementary Note 21)

The transport control apparatus according to supplementary note 19 or 20, wherein the identifying section is configured to identify the second control information from among two or more control parameters used for determining a transport instruction to the one or more transport apparatuses, based on the operation information related to the operation of the object in response to the first control information.

### (Supplementary Note 22)

The transport control apparatus according to any one of supplementary notes 16 to 21, further comprising a management section configured to hold association information in which path information and the second control information are associated with each other, the path information being information of a path to which a position where the operation of the target in response to the first control information is performed belongs.

### (Supplementary Note 23)

The transport control apparatus according to supplementary note 22, further comprising an instruction generation section configured to use the association information in which the path information and the second control information are associated with each other, to determine a transport instruction to a transport apparatus transporting the object moving the position identified by the path information.

### (Supplementary Note 24)

A transport control system comprising:

an obtaining section configured to obtain operation information related to operation of an object in response to first control information for controlling one or more transport apparatuses transporting the object; and

an identifying section configured to identify second control information used for controlling the one or more transport apparatuses, based on the operation information related to the operation of the object in response to the first control information.

### (Supplementary Note 25)

The transport control system according to supplementary note 24, further comprising a transmission processing section configured to transmit instruction information for controlling the one or more transport apparatuses to the one or more transport apparatuses, based on the second control information.

### (Supplementary Note 26)

The transport control system according to supplementary note 24 or 25, wherein the first control information is first instruction information for giving, to the one or more transport apparatuses, an instruction of operation for transport.

### (Supplementary Note 27)

The transport control system according to any one of supplementary notes 24 to 26, wherein the second control information is a parameter for control to be used for generating second instruction information to the one or more transport apparatuses.

### (Supplementary Note 28)

The transport control method according to any one of supplementary notes 24 to 27, wherein the one or more transport apparatuses include two transport apparatuses transporting the object in cooperation with each other.

### (Supplementary Note 29)

A program that causes a computer to execute processing including: obtaining operation information related to operation of an object in response to first control information for controlling one or more transport apparatuses transporting the object; and

identifying second control information used for controlling the one or more transport apparatuses, based on the operation information related to the operation of the object in response to the first control information.

### INDUSTRIAL APPLICABILITY

It is possible to transport an object appropriately by one or more transport apparatuses.

### REFERENCE SIGNS LIST

1 Transport Control System
100 Transport Control Apparatus
111 Reception Processing Section
113 Transmission Processing Section
121, 150 Obtaining Section
123, 160 Identifying Section
200 Object
300, 301, 302 Transport Apparatus
40 External Sensor Apparatus

What is claimed is:

1. A transport control method comprising:
obtaining operation information related to operation of an object in response to first control information for controlling one or more transport apparatuses transporting the object; and
identifying second control information used for controlling the one or more transport apparatuses, based on the operation information related to the operation of the object in response to the first control information.

2. The transport control method according to claim 1, wherein
the first control information is first instruction information for giving, to the one or more transport apparatuses, an instruction of operation for transport.

3. The transport control method according to claim 1, wherein
the second control information is a parameter for control to be used for generating second instruction information to the one or more transport apparatuses.

4. The transport control method according to claim 1, wherein
the one or more transport apparatuses include two transport apparatuses transporting the object in cooperation with each other.

5. The transport control method according to claim 3, wherein
the identifying of the second control information includes identifying the second control information from among two or more control parameters used for determining a transport instruction to the one or more transport apparatuses, based on the operation information related to the operation of the object in response to the first control information.

6. The transport control method according to claim 1, further comprising
holding association information in which path information and the second control information are associated with each other, the path information being information of a path to which a position where the operation of the target in response to the first control information is performed belongs.

7. The transport control method according to claim 6, further comprising
using the association information in which the path information and the second control information are associated with each other, to determine a transport instruction to a transport apparatus transporting the object moving the position identified by the path information.

8. A transport control apparatus comprising:
a memory storing instructions; and
one or more processors configured to execute the instructions to:
obtain operation information related to operation of an object in response to first control information for controlling one or more transport apparatuses transporting the object; and
identify second control information used for controlling the one or more transport apparatuses, based on the operation information related to the operation of the object in response to the first control information.

9. The transport control apparatus according to claim 8, wherein
the one or more processors are further configured to execute the instructions to
transmit instruction information for controlling the one or more transport apparatuses to the one or more transport apparatuses, based on the second control information.

10. The transport control apparatus according to claim 8, wherein
the first control information is first instruction information for giving, to the one or more transport apparatuses, an instruction of operation for transport.

11. The transport control apparatus according to claim 8, wherein
the second control information is a parameter for control to be used for generating second instruction information to the one or more transport apparatuses.

12. The transport control apparatus according to claim 8, wherein
the one or more transport apparatuses include two transport apparatuses transporting the object in cooperation with each other.

13. The transport control apparatus according to claim 11, wherein
the one or more processors are configured to execute the instructions to identify the second control information from among two or more control parameters used for determining a transport instruction to the one or more transport apparatuses, based on the operation information related to the operation of the object in response to the first control information.

14. The transport control apparatus according to claim 8, wherein
the one or more processors are further configured to execute the instructions to
hold association information in which path information and the second control information are associated with each other, the path information being information of a path to which a position where the operation of the target in response to the first control information is performed belongs.

15. The transport control apparatus according to claim 14, wherein
the one or more processors are further configured to execute the instructions to
use the association information in which the path information and the second control information are associated with each other, to determine a transport instruction to a transport apparatus transporting the object moving the position identified by the path information.

16. A transport control system comprising:
one or more apparatuses each including a memory storing instructions and one or more processors configured to execute the instructions, wherein
the one or more apparatuses are configured to:
obtain operation information related to operation of an object in response to first control information for controlling one or more transport apparatuses transporting the object; and
identify second control information used for controlling the one or more transport apparatuses, based on the operation information related to the operation of the object in response to the first control information.

17. The transport control system according to claim 16, wherein
the one or more apparatuses are further configured to
transmit instruction information for controlling the one or more transport apparatuses to the one or more transport apparatuses, based on the second control information.

18. The transport control system according to claim 16, wherein
the first control information is first instruction information for giving, to the one or more transport apparatuses, an instruction of operation for transport.

19. The transport control system according to claim 16, wherein
the second control information is a parameter for control to be used for generating second instruction information to the one or more transport apparatuses.

20. The transport control method according to claim 16, wherein
the one or more transport apparatuses include two transport apparatuses transporting the object in cooperation with each other.
